(19) United States
(12) Patent Application Publication
(10) Pub. No.: US 2019/0188783 A1
(43) Pub. Date: Jun. 20, 2019

(54) METHOD AND SYSTEM FOR PLACING A PURCHASE VIA SOCIAL MEDIA TAGGING

(71) Applicant: Melissa Bridgeford, San Francisco, CA (US)

(72) Inventor: Melissa Bridgeford, San Francisco, CA (US)

(21) Appl. No.: 16/227,590

(22) Filed: Dec. 20, 2018

Related U.S. Application Data
(60) Provisional application No. 62/608,088, filed on Dec. 20, 2017.

(51) Int. Cl. G06Q 30/06; G06Q 20/36; G06Q 50/00

(52) U.S. Cl. CPC G06Q 30/0643; G06Q 30/0619; G06Q 50/01; G06Q 20/363; G06Q 30/0635

(57) ABSTRACT

A system and method for purchasing an item seen in a picture or video on social media by tagging Stylust in the comment section of such picture or video, and preferably including the name of the item requested for purchase.

### BACKGROUND OF THE INVENTION

### Field of the Invention

This invention relates to a system and method for purchasing an item seen in a picture or video post on social media platforms (including but not limited to Instagram, Facebook, Pinterest, and YouTube) by tagging Stylust (the “Company”) in the comment section of such picture or video post. The application hereafter describes the system/method as it relates specifically for Instagram. The order is placed by a user (“User”) that observes a desired item in any picture or video on social media and then tagging the Company in the comment section and identifying the desired item in such comment. The Company receives the social media notification and thereafter, coordinates and completes the purchase of the desired item for the User, including sourcing of the exact or visually similar item available for purchase in the User's preferred sizing, purchasing such item for the User with the User's preferred payment method, and arranging delivery of such item to User's preferred delivery address.

### Background of the Invention

Users regularly review the internet and social media looking for the latest trends in fashion, culture, home goods, electronics, accessories, and general style. Instagram, in particular because of its highly visual content (all pictures or videos), and other social media platforms are increasingly becoming sources of inspiration for purchases over traditional media, such as magazines. However, there still remains a huge gap between this point of inspiration (when a User sees an item she'd like to buy in a picture) and the point of consumption (when the user completes the purchase of such item). Current methods involve the User leaving the social media platform to search the internet for such item and pursuing the traditional e-commerce process of purchase which has 3% conversion rates on average. The more clicks required by a User to purchase an item, the more likely that the User will abandon the purchase process along the way, resulting in the loss of potential sales/buying opportunity. Both sides lose. Closing the gap between the point of inspiration and the point of consumption is tremendously valuable to both the Users and the companies selling the products.

One-off solutions have created internal tagging or other identification mechanisms to allow companies or influencers to tag items in social media posts so that a User can be linked to a website where they may be able to purchase the item. However, this multi-step approach between the point of inspiration and the point of consumption still requires upwards of 10 clicks/steps, which is cumbersome, problematic and time consuming on a mobile device. Moreover, these one-off tagging solutions are only provided for certain products in a limited number of posts in specific brand/influencer feeds, which excludes millions of other items in those posts that are not tagged, in addition to the large majority of social media posts that do not use tagging technology at all. Stylust's methodology enables purchasing of items in all posts.

### SUMMARY OF THE INVENTION

For purposes of summarizing this invention, the present invention is directed to a method for placing a product purchase from a picture or video on social media via the tagging of the Company in the comment section of the post.

It is a principle object of this invention to provide a system and method for placing a product purchase from a picture or video on social media via one step only, simply by tagging the Company in the comment section of the post.

The system and method disclosed herein results in a purchasing system that is superior to what conventional wisdom in the field would predict and what currently exists.

### BRIEF DESCRIPTION OF THE DRAWINGS

For a fuller understanding of the nature and objects of the invention, reference should be had to the following detailed description taken in connection with the accompanying drawings in which:

FIG. 1 is a flow chart depicting the system and method of the present disclosure.

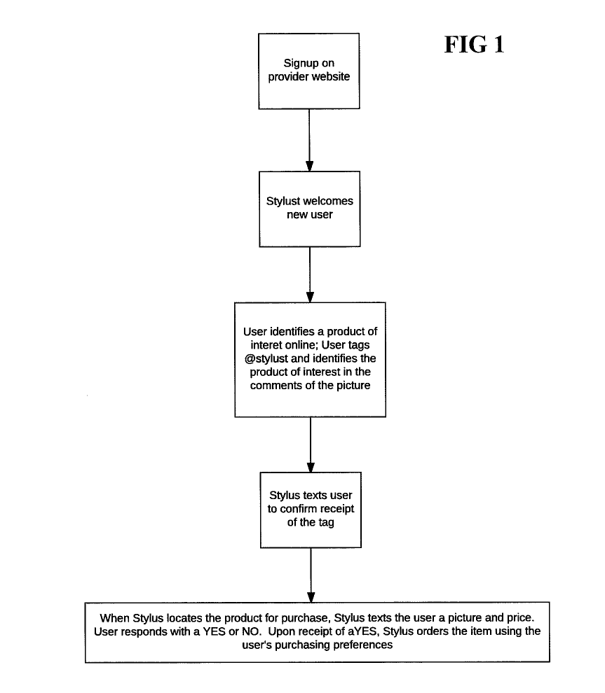

FIG. 2 is a screen shot showing an embodiment of the present disclosure being used to purchase a handbag.

Similar reference characters refer to similar parts throughout the several views of the drawings.

### DETAILED DESCRIPTION OF THE PREFERRED EMBODIMENT

In a preferred embodiment, a User will register on a website with a centralized server providing the features and capabilities of the present disclosure, hereinafter called Stylust. During this registration process, the User will create a customer profile/account by providing her personal information, including but not limited to name, address, email, cell phone, Instagram (or other social media) profile name, clothing sizes, and select their preferred method of payment. The User also has the ability to begin using the Stylust service without registering in advance on the website, but rather the User can tag Stylust in a post on social media and the Company will collect the registration information directly from the User and create a customer profile/account for the User. The centralized server will store this information and use this information later in the purchasing process as described below.

Through this registration process, the User will also enter into a contract with Stylust by agreeing with the Terms of Use, thereby allowing Stylust to thereafter make purchases on behalf of the User. Stylust may then send a welcome or introductory communication preferably via text or email to the User. Stylust may also provide a semi-personalized Instagram handle, such as @stylust2 to the User for such User to use when tagging an item of interest. While this description is provided in terms of Instagram, such a description is exemplary only, as the teachings of the present disclosure can be used with any social media service/platform.

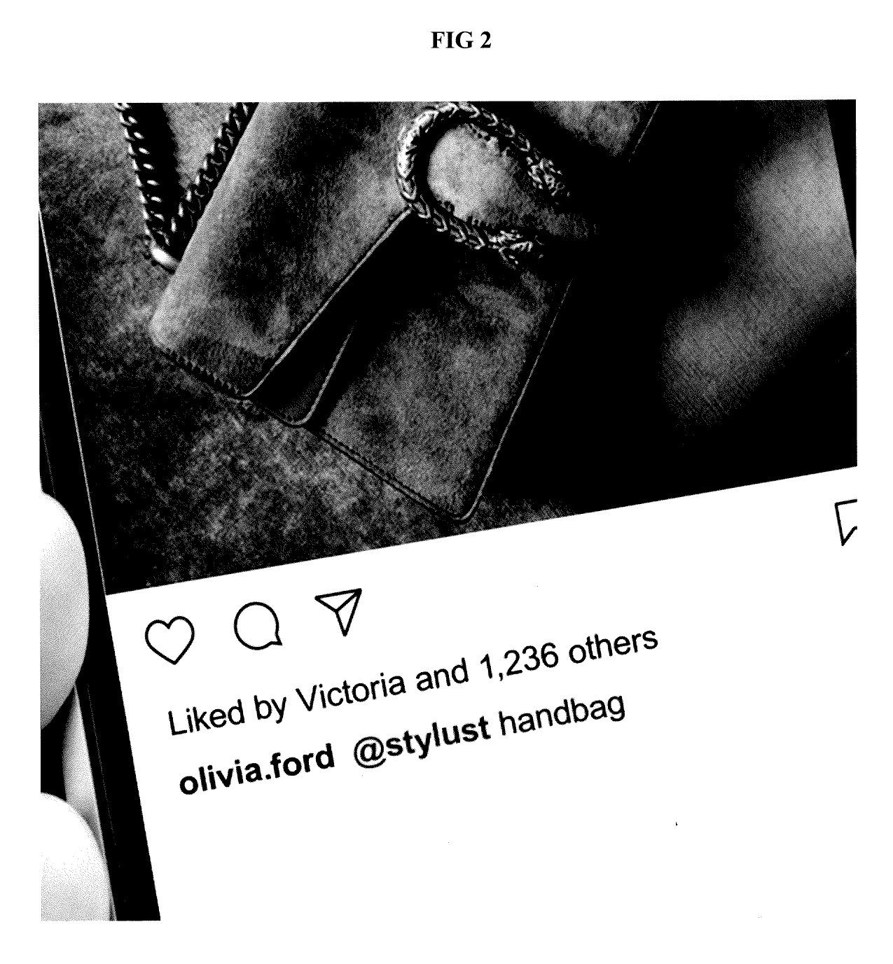

Upon seeing an item that the User wants to buy in a picture or video on social media, the User may then tag the @stylust Instagram handle or their semi-personalized Instagram handle in the comment section of such picture or video and name the item(s) of interest that the User wants to buy. For example, the User may see a picture on Instagram, where the subject of the photo is wearing a blouse that the User wants to buy. The User could then comment on that picture, using the @stylust handle or their semi-personalized handle, and name the item of interest, such as “@stylust blouse.” This is depicted in FIG. 2.

Upon receipt of notification of this tagging, Stylust will text the User to confirm receipt of such tag and that Stylust is in the processing of attempting to source the desired item. Stylust will then locate the exact item or a visually similar item that is available for purchase in the User's preferred sizing. Upon locating the item, Stylust will send a text to the User to confirm the item was located and communicate the price of the item. The User can then respond to the text “YES” or “NO.” If the User responds “YES,” Stylust will then order the item using the User's preferred purchasing method and arrange for the product to be delivered to the User directly. Through this method, the User is able to purchase a product from a picture on social media feed with just one step: tagging the Company in the comment section of that picture.

Because the purchase was made with the User's purchasing credentials and privileges, and sent directly to the User, the User can handle any returns directly with the vendor and can call the Company's customer service for help if needed.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A method as disclosed herein.
